(19) United States
(12) Patent Application Publication
(10) Pub. No.: US 2012/0215604 A1
(43) Pub. Date: Aug. 23, 2012

(54) SYSTEM AND METHOD INCLUDING REFERRAL PROCESSING

(75) Inventor: Matt Steven Canetto, Centennial, CO (US)

(73) Assignee: Visa International Service Association

(21) Appl. No.: 13/402,180

(22) Filed: Feb. 22, 2012

Related U.S. Application Data
(60) Provisional application No. 61/445,885, filed on Feb. 23, 2011.

(51) Int. Cl. G06Q 30/02

(52) U.S. Cl. 705/14.16

(57) ABSTRACT

A system and method to enable an account owner, such as a user of a pre-paid card, to invite another person to become a user of a pre-paid card. The account owner may find a person to “invite” based on the owner's email, contact list, social network contacts, or another suitable source of data. If the person receiving the invitation to apply for and open a pre-paid account opens such an account, then the person sending the invitation may receive an award or reward. In some cases, the person receiving the invitation may also receive an award or reward. The amount of the award or reward may depend on one or more factors, including the number of times the new account owner loads their pre-paid card, the number of transactions that the new account owner conducts using the pre-paid card, etc.

### CROSS-REFERENCES TO RELATED APPLICATIONS

This application claims the benefit of U.S. Provisional Application No. 61/445,885, entitled “System and Method Including Referral Processing,” filed Feb. 23, 2011 (Attorney Docket No. 79900-798465 (092300US)), the entire disclosure of which is hereby incorporated herein by reference.

### FIELD OF THE INVENTION

Embodiments of the present invention are directed to systems, apparatuses and methods for enabling the use of payment devices and the processing of transactions conducted using such devices. More specifically, the present invention relates to a product or service that enables an account owner, such as a user of a pre-paid card (or other form of reloadable device), to invite another person to become a user of that type of payment device. The person sending the invitation may receive a reward for referring the person invited, with the amount or timing of the reward being related to the invited person's use or amount of use of the new account or payment device.

### BACKGROUND

Payment devices such as credit cards, debit cards, and pre-paid cards are used by consumers to conduct payment transactions on a daily basis and with a variety of merchants. They provide a convenient and secure method to provide payment for goods or services and continue to increase in popularity. In some situations such payment devices may also be used to transfer funds between linked accounts owned by the same person. In the case of pre-paid cards, the growth in use of such cards has been limited by the need to provide a source of funds for use in “charging” the card, which naturally prevents the use of such cards by those lacking their own funds. This limits the penetration of such payment devices into the marketplace, and as a result, reduces the financial services that a bank, savings and loan, credit union, or other type of issuer can make available to certain potential customers. Further, because issuers typically desire to offer a range of financial products and services to a customer over the lifetime of a relationship with the customer, it is important to be able to attract and retain new customers. Pre-paid cards or similar payment devices might be useful as a way of attracting new customers to an issuer if the ease of use and attractiveness of such devices could be increased by overcoming some of the present obstacles to their usage.

What is desired are systems, apparatuses and methods for increasing the usage of payment devices such as pre-paid cards or other forms of reloadable cards. Embodiments of the invention address these problems and other problems individually and collectively.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the invention are directed to systems, apparatuses and methods for enabling consumers to conduct payment transactions using payment devices such as pre-paid cards or other forms of reloadable payment devices. Embodiments of the invention are also directed to systems, apparatuses and methods for assisting issuers to increase the market penetration and use of such payment devices by consumers.

In some embodiments, this is accomplished by providing elements of a service that enables an account owner, such as a user of a pre-paid card, to invite another person to become a user of that type of payment device. The person sending the invitation may receive a reward for referring the person invited, with the amount or timing of the reward being related to the invited person's amount of use of the new account. The present account owner may find a person to “invite” based on the account owner's email, contact list, social network contacts, or another suitable source of data. The invitation may include a link or identifier for the person sending the invitation so that any newly opened account can be associated with the sender of the invitation.

The amount of the reward may depend on the number of times the new account owner loads their pre-paid card, the number of transactions that the new account owner conducts using the pre-paid card, the amount of funds involved in the transactions that the new account owner conducts using the pre-paid card, or another suitable measure. In some embodiments, the new account owner may also receive a reward based on their usage of the new payment device. Fund transfers between the account owner's pre-paid (or other) account and the pre-paid account of the invited party may be managed using a user interface that permits the scheduling of transfers between the accounts.

Benefits of embodiments of the invention include providing incentives to current account owners to contact others and encourage them to open a pre-paid account, thereby increasing the penetration of pre-paid accounts with consumers. Embodiments of the invention also provide tools to enable the current account owner to manage the transfer of funds to the new account opened by the person who was “invited”. This may increase use of pre-paid accounts as well as facilitate new payment transactions that might not otherwise have occurred. Further, by encouraging the opening of a new account by the invited party, embodiments of the invention enable an issuer to effectively introduce their financial services to a new customer. This may lead to a long term relationship between the issuer and the new customer, providing benefits to both parties. Thus, embodiments of the invention provide a mechanism for assisting issuers to increase their customer base as well as the usage of pre-paid payment devices.

In some embodiments, the invention is directed to a computer-implemented method, where the method includes:

enabling a current owner of a pre-paid account to identify a person to invite to open a new pre-paid account;

generating an electronic invitation to the identified person on behalf of the current owner of the pre-paid account;

receiving acknowledgement that the identified person opened the new pre-paid account;

enabling the current owner of the pre-paid account to electronically transfer funds to the identified person who opened the new pre-paid account;

determining that the new pre-paid account has been used in a manner that satisfies a criteria for a referral reward;

providing the referral reward to the current owner of the pre-paid account; and

providing a user interface displayed on an electronic device and configured to permit the current owner of the pre-paid account to view a status of the invitation and a status of the referral reward.

In some embodiments, the invention is directed to an apparatus, where the apparatus includes:

an electronic processor programmed to execute a set of instructions; and

a data storage device coupled to the processor and having the set of instructions stored therein, wherein when the set of instructions are executed by the processor, the apparatus operates to

enable a current owner of a pre-paid account to identify a person to invite to open a new pre-paid account;

generate an electronic invitation to the identified person on behalf of the current owner of the pre-paid account;

receive acknowledgement that the identified person opened the new pre-paid account;

enable the current owner of the pre-paid account to electronically transfer funds to the identified person who opened the new pre-paid account;

determine that the new pre-paid account has been used in a manner that satisfies a criteria for a referral reward;

provide the referral reward to the current owner of the pre-paid account; and

provide a user interface displayed on an electronic device and configured to permit the current owner of the pre-paid account to view a status of the invitation and a status of the referral reward.

Other objects and advantages of the present invention will be apparent to one of ordinary skill in the art upon review of the detailed description of the present invention and the included figures.

### BRIEF DESCRIPTION OF THE DRAWINGS

Illustrative embodiments of the present invention are described in detail below with reference to the following drawing figures:

FIG. 1 is a flowchart or flow diagram illustrating a set of exemplary processes, operations, or functions that may be implemented by a suitably programmed processor or computing device, in accordance with some embodiments of the invention;

FIGS. 2(a), 3, 4, and 5(a)-5(d) illustrate screen shots of exemplary elements of a user interface that may be used to permit a user to generate and manage their invitations, transfer funds, and manage their subsequent referral rewards in accordance with some embodiments of the invention;

FIG. 2(b) is a flowchart or flow diagram illustrating a set of processes, operations, or functions that may be implemented by a suitably programmed processor or computing device in order to generate the exemplary user interface elements of FIG. 2(a) and to permit a user to interact with those elements;

FIG. 5(e) is a flowchart or flow diagram illustrating a set of processes, operations, or functions that may be implemented by a suitably programmed processor or computing device in order to generate the exemplary user interface elements of FIG. 5(c) and to permit a user to interact with those elements;

FIG. 6 is a functional block diagram illustrating the primary functional elements of an exemplary system for conducting an electronic payment transaction and processing payment transaction data, certain elements of which may have a role in implementing and utilizing an embodiment of the invention; and

FIG. 7 is a block diagram of elements that may be present in a computing device or system configured to execute a method or process in accordance with some embodiments of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Payment devices such as debit cards or credit cards are used by millions of people worldwide to facilitate various types of commercial transactions. These transactions generate a significant amount of transaction fees and processing fees, and as a result, a very competitive market exists for the issuance and management of payment devices and accounts. This has resulted in a large variety of payment devices, payment device features, pricing strategies, incentive programs for consumers, loyalty programs, and other features intended to differentiate an issuer's payment device or a payment processor's services in the marketplace and to target specific intended users of the payment devices and services.

As payment device issuers and payment processing organizations compete in the marketplace to increase the number of accounts they manage and the value of those accounts, they may develop new programs, products, and services that are intended to attract and retain new account owners. One example of this is the present invention, which includes a set of processes or operations to enable an account owner, such as a user of a pre-paid card, to invite another person to become a user of a pre-paid card. The present account owner may find a person to “invite” based on the account owner's email, contact list, social network contacts, or another suitable source of data. If the person receiving the invitation to apply for and open a pre-paid account (or other form of payment device) does open such an account, then the person sending the invitation may receive an award or reward. In some embodiments, the person receiving the invitation may also receive an award or reward. The amount of the award or reward may depend on one or more factors, including, but not limited to, the number of times the new account owner loads their pre-paid card, the number of transactions that the new account owner conducts using the pre-paid card, the amount of funds involved in the transactions that the new account owner conducts using the pre-paid card, or another suitable measure.

In some embodiments, the person sending the invitation may configure their pre-paid account to transfer funds to the pre-paid account of the person receiving the invitation. In some embodiments, the person sending the invitation may send an enrollment code to the person receiving the invitation. The enrollment code may be used to identify the sender of the invitation during the enrollment process conducted by the recipient of the invitation. This enables a system that implements an embodiment of the present invention to track the successful referrals generated by the sender of the invitation and arrange for them to receive their award or reward when the appropriate conditions are satisfied.

In general, the inventive service (which may be referred to herein as “Invite and Fund Others”) involves one or more of the following elements:

(1) A current owner of a pre-paid account (and typically an associated pre-paid card or other form of payment device) generates an invitation to another person, inviting them to apply for and receive a pre-paid account. The invited person (or recipient of the invitation) may be a friend, family member, someone with whom the current owner has exchanged email (e.g., a person whose email address is part of the current owner's contact list), or member of a common social network. The invitation may include a link or other form of identifier for the current account owner that permits an account opened by the invited person to be associated with the current account owner;

(2) If the invited person opens a pre-paid account and uses it in a way that satisfies certain criteria (which are typically set by the issuer and may include such criteria as the number of times the pre-paid account is “loaded” with funds, the value of funds loaded into the new pre-paid account, the number of transactions that the invited person uses the new pre-paid account for, the total value of the transactions which the invited person uses the new pre-paid account for, or another suitable measure), then depending on the policies of the issuer, either (or both of) the person who sent the invitation or the new pre-paid account owner may receive a reward; and

(3) A user-interface (typically accessible using a web-page that is “served” to a user) is available to permit the person who sent the invitation to select people to invite, transfer funds from their pre-paid account to that of the new pre-paid account owner, to schedule the transfer(s), and to manage their rewards, among other tasks.

Embodiments of the present invention may include one or more of the following concepts, features or elements:

Card Referral—This term describes the process of a current pre-paid cardholder soliciting a non-cardholder to enroll in the pre-paid card program. The Card Referral process may include communication of an identifier for the current pre-paid cardholder (e.g., the cardholder's Enrollment Code) to the non-cardholder so that the non-cardholder can enter the code during the enrollment process;

Card Referral Trigger—This term describes a specific number of card loads, value of the card loads, or another suitable measure (typically as determined by an issuer) that triggers a Card Referral Reward. Once a referred pre-paid cardholder achieves a Card Referral Trigger through a successful series of activities, the Card Referral process is completed and may trigger a Card Referral Reward to the referring pre-paid cardholder (and in some embodiments to the referred or invited cardholder);

Card Referral Reward—This term describes the credit (typically in the form of funds placed into an account) received by the referring and/or the referred pre-paid cardholder when a Card Referral Trigger is achieved by the referred pre-paid cardholder;

Funds Transfer Request—This term describes the request of funds from one pre-paid cardholder to another. The Funds Transfer process typically includes the communication of the requesting pre-paid cardholder's Enrollment Code to the receiving cardholder so that the receiving cardholder can enter the code when adding the requesting pre-paid cardholder as a Transfer-To Account (note that in the converse case of one pre-paid cardholder offering to transfer funds to another person, the enrollment code of the recipient of the transfer would be provided to enable the provider of the funds to establish the recipient as a transfer-to-account);

PPC-to-PPC (pre-paid card to pre-paid card) Funds Transfer (PPC FT)—This term describes the debit transaction when a cardholder transfers funds from his/her pre-paid account to another cardholder's pre-paid account;

PPC FT credit—This term describes the credit transaction when a cardholder receives a load of funds to his/her pre-paid account from another cardholder's pre-paid account;

Enrollment Code—This term describes the code or identifier used to associate an enrolling cardholder with an existing cardholder for the purposes of crediting the existing cardholder with a Card Referral Reward once a Card Referral Trigger has been achieved. This term also describes the code or identifier used by a cardholder to add another cardholder as a Transfer-to Account in order to initiate a PPC FT to the Cardholder Transfer-to Account.

Further, embodiments of the present invention may include systems, apparatus, or devices configured to implement one or more of the following functions, operations, processes, or services:

A Configurable Card Referral functionality or process for a reloadable program cardholder or account holder to enable the cardholder to invite someone to become a pre-paid cardholder or account holder. This functionality may include a Card Referral Reward program so that the referring and/or the referred cardholder or account holder receives a credit for an amount determined by an issuer to his/her account once the referred cardholder satisfies one or more criteria or measures (which may be referred to as a Card Referral Trigger);

A Configurable Card-to-Card Funds Request functionality or process for a reloadable cardholder or account holder to enable generation of a request to receive money from another cardholder or account holder (note that this may also be implemented as an “offer” from one cardholder to another to provide funds to the other cardholder). The Funds Request may include the cardholder's Enrollment Code so that the recipient can add the cardholder as a Transfer-To Account; and

A Configurable Pre-paid Card to Pre-paid Card Funds Transfer functionality or process for a reloadable cardholder to enable the cardholder to schedule and manage the transfer funds from his/her pre-paid account to the requesting cardholder's pre-paid account (or to the account associated with the person to whom the transfer was “offered”). This functionality or process may include the ability to enter another cardholder's Enrollment Code and add that cardholder as a Transfer-To Account. It may also include the ability to utilize a suitable user interface to view, edit and delete existing scheduled transfers to other cardholders as part of managing the fund transfers.

An example embodiment of the invention will now be described with reference to the included figures. Prior to discussing specific embodiments of the invention, a further description of certain terms is provided to enable a better understanding of the embodiments of the invention and the context in which those embodiments may be implemented.

A “payment device” or “portable consumer device” may include any suitable device capable of being used to provide payment for a transaction (where such a transaction may include a purchase of a product or service). For example, a payment device can take the form of a card such as a credit card, debit card, pre-paid card, charge card, gift card, or any combination thereof. The card or substrate may include a contactless element in which is stored payment account data. Further, a payment device may take the form of a device other than a card which incorporates a data storage element in which is contained data that may be used to conduct a payment transaction. Examples of such devices include mobile phones, PDAs, portable computing devices, etc.

A “payment processing network” (e.g., VisaNet™) is one or more entities (e.g., computing and/or data processing elements) that are capable of communication and data transfer over a suitable communication network or networks, and which is used to perform operations involved in the processing of payment transactions. A payment processing network may include data processing subsystems, networks, and operations used to support and deliver transaction authorization services, consumer authentication services, exception file services, and transaction clearing and settlement services. An exemplary payment processing network may include one or more of the components or elements that are present in VisaNet™. Payment processing networks such as VisaNet™ are able to process credit card transactions, debit card transactions, pre-paid card transactions, and other types of commercial transactions. VisaNet™ in particular, includes a VIP system (Visa Integrated Payments system) which processes authorization requests and a Base II system which performs transaction clearing and settlement services. A payment processing network may use any suitable wired or wireless network, including the Internet, to facilitate communications and data transfer between its component system elements.

An “authorization request message” may be generated by an entity (e.g., a merchant) that is part of (or in communication with) a payment processing network as part of the process of obtaining authorization to conduct a payment transaction. Such a message can include a request for authorization to conduct the payment transaction and may include an issuer account identifier. The issuer account identifier may be a payment card account identifier associated with a payment card. The authorization request message may request that the issuer of the payment card (or payment device) authorize a payment transaction. An authorization request message may comply with ISO 8583, which is a standard for systems that exchange electronic transactions conducted by cardholders using payment cards.

An “authorization response message” may include an authorization code, and is typically produced by an issuer in response to receiving and processing an authorization request message as part of determining whether to approve or deny a requested transaction. Other entities or elements that are part of (or in communication with) a payment processing network may also be involved in determining whether to approve or deny a requested transaction.

A “server computer” can be a powerful computer or a cluster of computers. For example, the server computer may be a large mainframe, a minicomputer cluster, or a group of servers functioning as a unit. In one example, the server computer may be a database server coupled to a Web server. A payment processing network may include one or more server computers.

A “terminal” (e.g. a point-of-service or point-of-sale (POS) terminal) can be any suitable device configured to allow a consumer or merchant to initiate (and in some cases, process) a payment transaction, such as a credit card or debit card transaction, a prepaid card transaction, a load transaction, or an electronic settlement transaction. The terminal may include optical, electrical, or magnetic elements configured to read data from portable consumer devices such as a smart card, a keychain device, a cell phone, a payment card, a security card, an access card, etc.

An “acquirer” is a business entity (e.g., a commercial bank) that typically has a business relationship with a merchant and receives some or all of the transactions conducted with that merchant. The acquirer assists in the authorization and processing of the transactions.

An “issuer” is a business entity which issues a card or other form of payment device to a consumer or card holder. The issuer is typically a financial institution such as a bank, credit union, savings and loan, etc. The issuer assists in the authorization and processing of transactions for consumers, and typically also provides administrative and management services for the account associated with the payment device.

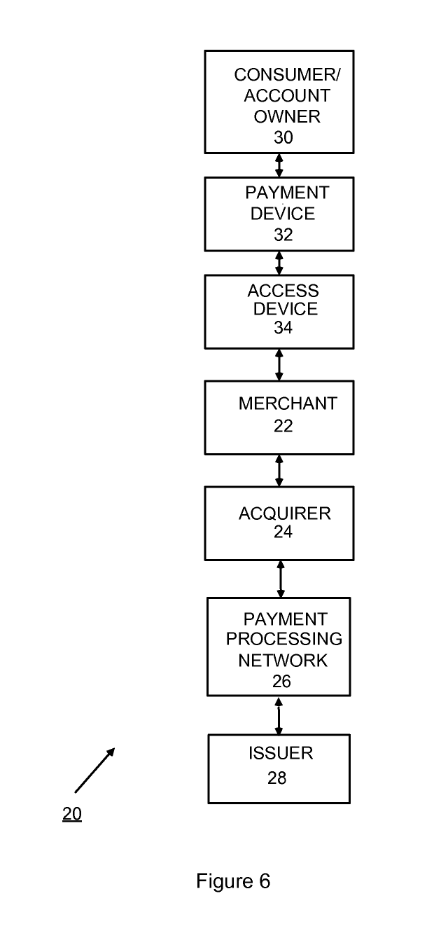

In order to provide an example of the context in which the present invention may be implemented, a brief discussion of the entities involved in processing and authorizing a payment transaction (and their roles in the processing of payment transaction data) will be presented. FIG. 6 is a functional block diagram illustrating the primary functional elements of an exemplary system 20 for conducting an electronic payment transaction and processing payment transaction data, certain elements of which may have a role in implementing and utilizing an embodiment of the invention.

In a typical payment transaction, an account owner (e.g., an individual consumer) provides a payment account or payment device identifier to a merchant or service provider. The payment account or payment device identifier may be provided in the form of a card (e.g., a magnetic stripe card or smart card with an embedded chip) accessed by a point of sale terminal or card reader, by a contactless device embedded in another device (e.g., a mobile phone, PDA, etc.) that communicates with a point of sale terminal using a short range wireless communications technique, or by another suitable form.

Typically, an electronic payment transaction is authorized if the consumer (which is typically the account owner) conducting the transaction is properly authenticated (i.e., their identity and their valid use of a payment account is verified) and has sufficient funds or credit to conduct the transaction. Conversely, if there are insufficient funds or credit in the account, or if the payment device is on a negative list (e.g., it is indicated as possibly having been stolen), then an electronic payment transaction may not be authorized.

As shown in FIG. 6, in a typical transaction, a consumer/account owner 30 wishing to purchase a good or service from a merchant provides transaction data that may be used as part of a transaction authorization process, typically by means of a payment device 32. Consumer 30 may utilize a payment device 32 such as a card having a magnetic stripe encoded with account data (e.g., a standard credit or debit card, or pre-paid card) to initiate the transaction. In an eCommerce (electronic commerce) transaction, the account owner may enter data into a device capable of communicating with a merchant or other element of system 20, such as a laptop or personal computer.

The consumer may also initiate the transaction using data stored in and provided from a suitable form of data storage device (such as a smart card, mobile phone or PDA containing a contactless element, or a transportable memory device). As examples, a card or similar payment device may be presented to a point of sale terminal which scans or reads data from the card or device. A consumer may enter payment account data into a cell phone or other device capable of wireless communication (e.g., a laptop computer or personal digital assistant (PDA)) and have that data communicated by the device to the merchant, the merchant's data processing system, or a transaction authorization network. A wireless device may also be used to initiate a payment transaction by means of communication between a contactless element embedded within the device and a merchant device reader or point of sale terminal using a short range communications mechanism, such as RF, infra-red, optical, near field communications (NFC), etc. Thus, in some cases an access device 34 may be used to read, scan, or otherwise interact with a payment device and thereby obtain data used in conducting a payment transaction.

The payment account data (and if needed for processing the transaction, other account owner data) is obtained from the consumer/account owner's device and provided to the merchant 22 or to the merchant's data processing system. The merchant or merchant's data processing system generates a transaction authorization request message that may include data obtained from the payment device as well as other data related to the transaction or to the merchant. As part of generating the authorization request message, the merchant 22 or the merchant's transaction data processing system may access a database which stores data regarding the account owner, the payment device, or the account owner's transaction history with the merchant.

The merchant transaction data processing system typically communicates with a merchant acquirer 24 (e.g., a commercial bank which manages the merchant's accounts) as part of the overall transaction authorization process. The merchant's transaction data processing system and/or merchant acquirer 24 provide data to Payment Processing Network 26, which among other functions, participates in the clearance and settlement processes which are part of the transaction processing. Payment Processing Network 26 may be operated in whole or in part by a payment processing organization such as Visa. As part of the transaction authorization process, an element of Payment Processing Network 26 may access an account database which contains information regarding the account owner's payment history, chargeback or dispute history, credit worthiness, etc. Payment Processing Network 26 communicates with issuer 28 as part of the authorization process, where issuer 28 is the entity that issued the payment device to the account owner and provides administrative and management services for the consumer's payment account. Account data is typically stored in an account owner database which is accessed by issuer 28 as part of the transaction authorization and account management processes.

In standard operation, an authorization request message is created during a purchase (or proposed purchase) of a good or service at a point of sale (POS). The point of sale may be a merchant's physical location or may be a virtual point of sale such as a web-site that is part of an eCommerce transaction. In a typical transaction, the authorization request message is sent from the point of sale (e.g., the merchant or the merchant's transaction data processing system) to the merchant's acquirer 24, then to the Payment Processing Network 26, and then to the appropriate issuer 28. An authorization request message may include a request for authorization to conduct an electronic payment transaction. It may include one or more of an account owner's primary account number (PAN), payment device expiration date, currency code, sale amount, merchant transaction stamp, acceptor city, acceptor state/country, etc. An authorization request message may be protected using a secure encryption method (e.g., 128-bit SSL or equivalent) in order to prevent data from being compromised.

Payment device 32 may be in any suitable form and may incorporate a contactless chip or other element that facilitates payment transactions. For example, suitable payment devices can be hand-held and compact so that they can fit into a wallet and/or pocket (e.g., pocket-sized). They may include contact or contactless smart cards, credit or debit cards (typically with a magnetic stripe and without an embedded microprocessor), pre-paid cards, keychain devices (such as the Speedpass™ which is commercially available from Exxon-Mobil Corp.), and depending upon the specific device, may incorporate a contactless element that is configured to enable the device to participate in payment transactions. Other examples of suitable payment devices include cellular phones, personal digital assistants (PDAs), pagers, payment cards, security cards, access cards, smart media, transponders, and the like, where such devices may incorporate a contactless element. Depending upon the specific design, the payment device may function as one or more of a debit device (e.g., a debit card), a credit device (e.g., a credit card), or a stored value device (e.g., a stored value or pre-paid card).

Payment Processing Network 26 may comprise or use a payment processing network such as VisaNet™. Payment Processing Network 26 and any communication network that communicates with Payment Processing Network 26 may use any suitable wired or wireless network, including the Internet. Payment Processing Network 26 may be adapted to process debit card, credit card, or pre-paid card transactions, in addition to processing transactions associated with the loading and/or reloading of value on a payment device or portable consumer device (such as a pre-paid card).

As noted, a payment processing network (e.g., VisaNet) may include a plurality of data processing devices, such as computers, servers, or central processing units that are interconnected by a suitable network or networks. The data processing devices may be used to support authorization, clearing, and settlement services (as described below) for users of the payment processing network, where these services may be applied as needed to various types of transactions:

Authorization—the necessary functions or operations to enable an issuer to approve or decline a transaction before a purchase is finalized or cash is disbursed;

Clearing—the necessary functions or operations to support the process of delivering a transaction from an acquirer to an issuer for posting to a consumer's account; and

Settlement—the necessary functions or operations to support the process of calculating and determining the net financial position of each party for all transactions that are cleared.

The authorization, clearance, and settlement functions are typically performed by exchanging messages between the elements of the payment processing network and the entities that interact with that network (such as the acquirer and issuer). Depending on the function being performed and the type or format of a message, a message may contain one or more of information about the transaction (e.g., the date, type of transaction, amount of the transaction, the merchant involved, etc.), information about the consumer conducting the transaction (e.g., the consumer's account number, security code, etc.), information about the merchant with whom the consumer is conducting the transaction (e.g., a merchant code or other identification, etc.), or information about the status of the processing of the transaction (e.g., a flag or indicator of whether the transaction has been approved or declined, etc.). A message may also include information about the transaction that is used by the elements of the payment processing network and/or the entities that interact with that network to perform their respective data processing functions (e.g., generating a risk or fraud score, etc.). The messages typically have a format or structure in which certain information is found in a defined field or region of the message. In addition to one or more defined fields, a message may also include one or more discretionary fields in which other forms or types of data may be placed.

In a payment processing network such as VisaNet, the primary components are VisaNet Interchange Centers (VICs), VisaNet Access Points (VAPs) and other network connections, and Processing Centers. These components are arranged in an architecture that provides consumers, merchants, acquirers, and issuers with the services needed for authorization, clearance, and settlement of transactions.

A VisaNet Interchange Center (VIC) is a Visa data processing center. Each VIC houses computer systems that perform VisaNet transaction processing. The VIC serves as the control point for the telecommunications facilities of the VisaNet Communications Network, which comprises high-speed leased lines or satellite connections based on IBM SNA and TCP/IP protocols.

A VisaNet Access Point (VAP) is a Visa-supplied computer system (located at a processing center) that provides an interface between the center's host computer and the VIC. The VAP facilitates the transmission of messages and files between the processing center host and the VIC, supporting the authorization, clearing, and settlement of transactions. Visa also provides other connection options for interacting with VisaNet that do not require VAPs.

A processing center is a data processing facility operated by (or for) an issuer or an acquirer. The processing center houses card processing systems that support merchant and business locations and maintain cardholder data and billing systems. As a form of redundancy, each processing center communicating with VisaNet may be linked to two VICs. Processing centers are connected to the closest, or primary, VIC. If one VIC experiences a system interruption, then VisaNet automatically routes members' transactions to a secondary VIC, thereby ensuring continuity of service. Each VIC may also be linked to one or more of the other VICs. This link enables processing centers to communicate with each other through one or more VICs. Processing centers can also access the networks of other card programs through the VIC.

A VisaNet Interchange Center typically houses the following VisaNet systems that provide both online and offline transaction processing:

(1) the VisaNet Integrated Payment (V.I.P.) System, which includes the BASE I System and the Single Message System (SMS);

### (2) the BASE II System; and

### (3) the VisaNet Settlement Service (VSS).

Together, these VisaNet systems perform part or all of the transaction authorization, clearing, and settlement functions.

The V.I.P. System is the primary online transaction switching and processing system for online authorization and financial request transactions that enter VisaNet. V.I.P. has one system that supports dual-message processing (authorization of transactions is requested in a first message, while financial clearing information is sent in a second message), and another system that supports single-message processing (the processing of interchange card transactions that contain both authorization and clearing information in a single message). In both cases, settlement occurs separately.

BASE I is the component of the V.I.P. System that processes authorization-only request messages online. Authorization request messages are typically the first messages sent in dual-message processing (where BASE II clearing messages are the second messages sent in dual-message processing). The BASE I component of the V.I.P. System supports online functions, offline functions, and the BASE I files. BASE I files include the internal system tables, the BASE I Cardholder Database, and the Merchant Central File. The BASE I online functions include dual-message authorization processing. BASE I online processing involves routing, cardholder and card verification, and stand-in processing (STIP), plus related functions, such as Card Verification Value (CVV) validation, PIN verification, and file maintenance.

A bridge from BASE I to SMS makes it possible for BASE I members to communicate with SMS members and to access the SMS gateways to outside networks. The BASE I offline functions include BASE I reporting and the generation of Visa Card Recovery Bulletins. BASE I reporting includes authorization reports, exception file and advice file reports, and POS reports.

The Single Message System (SMS) component of the V.I.P. System processes full financial transactions. Full financial transactions contain both authorization and clearing information. Because the authorization and clearing information is contained in one message, this form of processing is referred to as single-message processing. SMS also supports dual-message processing of authorization and clearing messages, communicating with BASE I and accessing outside networks, as required, to conduct transaction processing.

SMS supports online functions, offline functions, and the SMS files. The SMS files comprise internal system tables that control system access and processing, and the SMS Cardholder Database, which contains files of cardholder data used for PIN verification and for stand-in processing (STIP) authorization. The SMS online functions perform real-time cardholder transaction processing and exception processing. This processing supports both authorizations and full financial transactions. In addition, SMS supports the delivery of transactions to the BASE II System for members that use dual-message processing. SMS also accumulates reconciliation totals, performs activity reporting, and passes activity data to VisaNet, which supports settlement and funds transfer processing for SMS. VisaNet typically handles settlement and funds transfer as an automatic follow-up to SMS transaction processing. The SMS offline systems process settlement and funds transfer requests and provide settlement and activity reporting. They also support an offline bridge to and from BASE II for those Visa and Plus clearing transactions that are sent between an SMS member and a BASE II member.

The BASE II System is an international electronic batch transaction clearing system for the exchange of interchange data between acquirers and issuers. The system calculates interchange fees between members. BASE II performs the second part of dual-message processing. Through a BASE I System connection, members submit authorization messages, which are cleared through a VisaNet connection to BASE II. A bridge to the V.I.P. System permits interchange between BASE II processing centers and SMS processing centers.

The VisaNet Settlement Service (VSS) consolidates the settlement functions of SMS and of BASE II, including Interlink, into a single service for all products and services. Members and processors receive settlement information from SMS and from BASE II in a standardized set of reports. VSS provides flexibility in defining financial relationships, in selecting reports and report destinations, and in establishing funds transfer points. VisaNet processes interchange transactions for SMS and for BASE II through separate systems.

As noted, information passes between members and V.I.P. in the form of messages. For use with VisaNet, BASE I, and SMS, those messages may be variations of the International Organization for Standardization (ISO) 8583 message, which is the international standard for the format of financial messages. Each message contains bit maps that specify the data fields that appear in the message, a message type identifier, and those fields that are needed for the specific function intended. The message header contains basic message identifiers and routing information, along with message processing control codes and flags. The message type identifier specifies the message class and the category of the function that is to be implemented. For instance, 0100 indicates an authorization request. A bit map specifies which data fields are in a message. In addition to a primary bit map, messages can include secondary (and other) bit maps. Each map contains 64-bit fields, corresponding to the number of possible fields in a message. The data fields contain the information needed to process a message.

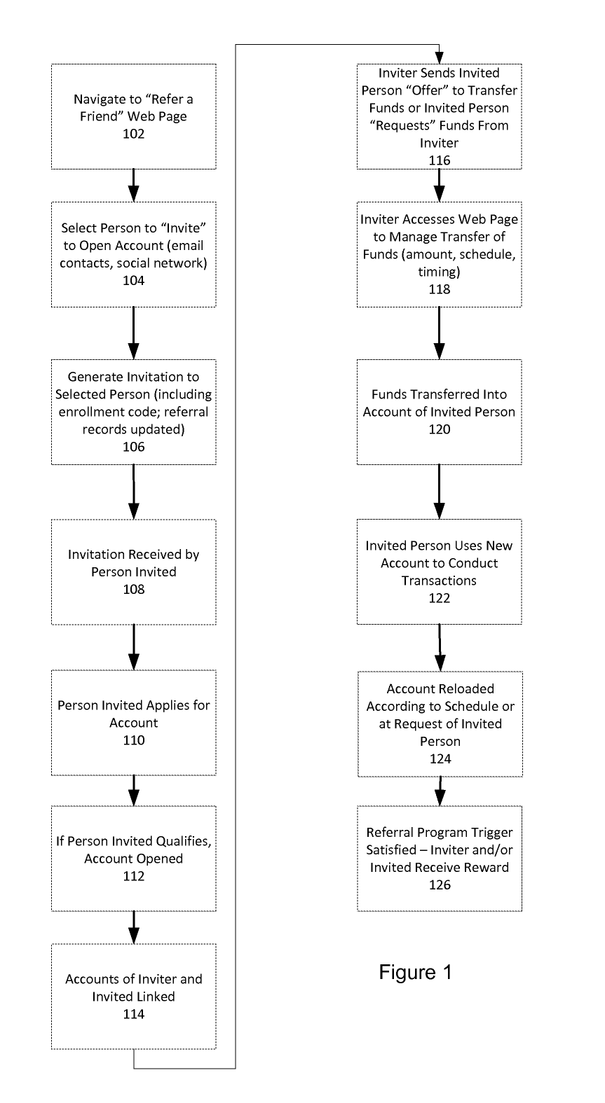

FIG. 1 is a flowchart or flow diagram illustrating a set of exemplary processes, operations, or functions that may be implemented by a suitably programmed processor or computing device, in accordance with some embodiments of the invention. Note that not all of the illustrated steps or stages may occur in all embodiments of the invention. As shown in the figure, in some embodiments a user (typically a consumer) may launch a browser and navigate to a web page from which they may access one or more of the processes, methods, functions, or operations associated with the “Refer a Friend” program that may be implemented as a part of (or the entirety of) an embodiment of the invention (102). In some embodiments, the consumer is an owner of a pre-paid account that has been issued by an issuer (although other types of accounts, such as credit card, debit card, payroll card, etc. accounts may be the subject of the inventive service). The consumer selects a person to “invite” to open an account (104). The invited person may be selected by any suitable manner and from any suitable list or group of persons. In some embodiments, the consumer (the “inviter”) may access a contact list or other form of presenting a set of email contacts. For example, a drop-down menu might be presented to the consumer with the names of all persons in their contact list used to populate the menu. The consumer may enter a phone number and have that information used to identify a person to whom an invitation will be sent. In some embodiments, the consumer may access a social network of which they are a member. After accessing the social network the consumer may be enabled to access contact information for a member of that network (such as a “friend” or other person known to the consumer, or with whom they have interacted using the social network).

After selecting one or more persons who will be sent an invitation, the consumer may enter their contact data or other data into a text box or other user interface element. This may be performed manually or automatically upon selection of the person or persons to “invite”. The consumer may then activate a user interface element that results in generating an invitation to the selected person or persons (106). The invitation may include an offer to apply for a pre-paid account or other form of financial service. In some embodiments, the invitation may include an “enrollment code” or other form of identifier for the consumer who sent the invitation (the inviter). The enrollment code or identifier may then be used by the invited person when they apply for the account in order to permit the inventive system to track the invitations sent by the consumer and the response to those invitations. This will enable the inviter to receive their “reward” when the invited person opens a new account and uses the account in a manner that satisfies the criteria for the inviter to receive a referral reward.

The generated invitation is then provided to the invited person, typically via email or another form of communication (108). The invited person may then apply to an issuer or other entity for an account (110). In some embodiments, this may occur as the result of the invited person activating a link that provides them with a web page through which they may request a new account. Applying for a new account may require that the invited person submit certain information to the issuer, such as identification information, credit history information, work experience information, etc. The issuer may then evaluate the submitted information to determine if the invited person qualifies for an account. In some embodiments, qualification may be determined in whole or in part by a relationship between the invited person and the inviter (e.g., a parent as the inviter and a child as the invited), or by some way in which the inviter vouches for the invited person (e.g., by a form of insurance, bond, or deposit of funds). If the invited person qualifies, then a new account may be opened (112). After the new account is established, the inviter may send the invited person (the owner of the new account) an offer to transfer funds from the inviter's account to the invited person's account (116). Conversely, the invited person may request that the inviter transfer funds to the invited person's accounts (116).

The inviter may then access a web page to interact with tools (such as user interface elements) that enable the inviter to schedule or otherwise manage a transfer of funds from their account to the newly opened account of the invited person (118). In some embodiments the inviter may be able to set one or more parameters of the transfer, including but not limited to, an amount of funds to be transferred, a date at which the transfer is to occur, a frequency at which a regular transfer is to occur, etc. At the desired time and after any further authentication or authorization processes that may be required by the issuer or other entity, the funds are transferred into the account of the invited person (120). In some embodiments and for purposes of example, this may mean that a pre-paid account associated with the invited person is “loaded” with some (or all) of the transferred amount.

The invited person/new account owner then uses the loaded pre-paid account to conduct transactions (122). This may involve conducting a certain number of transactions, each for a certain amount. In some embodiments, the invited person's account may be reloaded in accordance with one or more of a schedule, upon satisfaction of some criteria (such as reaching a specified balance), at the further request of the invited person, or based on a further offer from the inviter (124). Based on the criteria, rules, or requirements of the issuer or other entity, the invited person's usage of the new account may “trigger” receipt of a referral reward for the inviter (126). In some embodiments, this reward may be in the form of funds deposited into the inviter's account. In some embodiments, the referral reward may be triggered by a certain number of transactions conducted by the invited person using the new account, by a certain total value of transactions conducted using the new account, or by a certain number of reload processes conducted on the new account, for example. In some embodiments, the referral reward may be awarded to both the inviter and the invited person. In some embodiments, the referral reward may be a form of incentive instead of, or in addition to, funds (such as a coupon, discount, eligibility for a premium service or product, etc.).

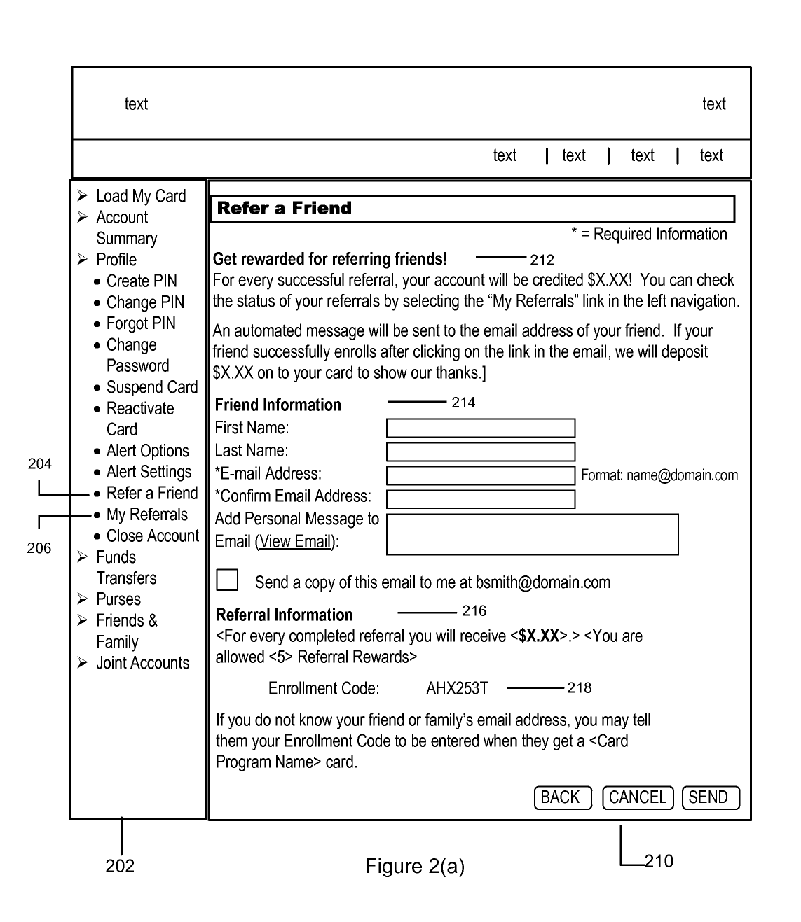

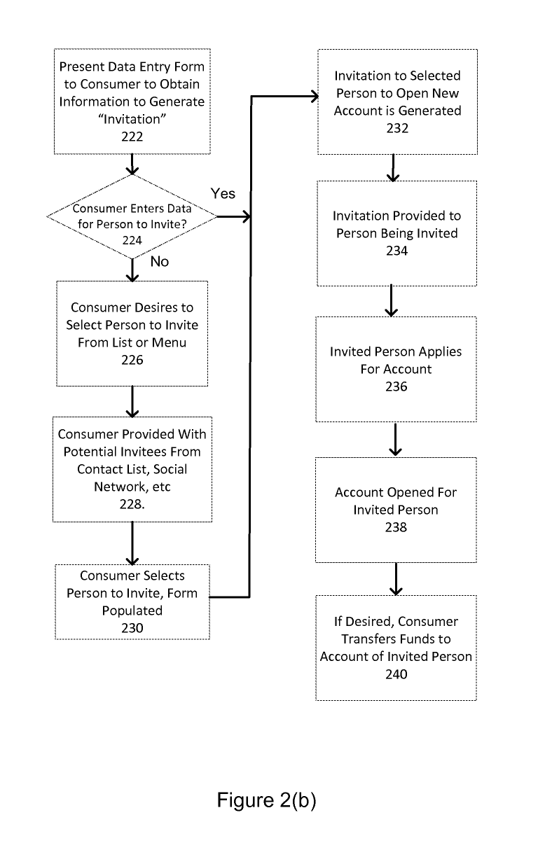

FIGS. 2(a), 3, 4, and 5(a)-5(d) illustrate screen shots of exemplary elements of a user interface that may be used to permit a user to generate and manage their invitations, transfer funds, and manage their subsequent referral rewards in accordance with some embodiments of the invention. The screen shots provide examples of a user interface that may be generated by embodiments of the present invention to permit an account owner (such as a user of a pre-paid card or other payment device) to “invite” another person to apply for a similar account. The user interface also permits the person sending the invitation to provide their enrollment code to the person being invited, as well as to view their referrals, request a transfer of funds from their own account to the account of the invited person, schedule a transfer of funds to the invited person's account, and track when they receive a reward for a successful referral. Note that the user interface elements shown in each figure are for purposes of example and that fewer elements, more elements, or different user interface elements may be used in implementations of embodiments of the invention without departing from the underlying concepts of the invention.

Note that the user interface depicted in the figures may represent a web-page that is presented to a user, with the user interface including one or more elements (such as radio buttons, drop-down menus, selectable elements, data entry fields) that may be selected and/or activated by a user. The display of the user interface may result from any suitable method, including the execution of code or instructions, interpretation of markup language, etc. by a processing element (such as a browser or other application, computer, microprocessor, central processing unit, etc.). Further, the response to (or processing of) the selection or activation of a user interface element may be the result of the execution of code or instructions, interpretation of markup language, etc. by a processing element (such as a browser or other application, computer, microprocessor, central processing unit, etc.). Thus, in some embodiments a method, process, function, or operation may be implemented as a result of the execution of code or a set of instructions by a suitably programmed processor or computing device.

Note that each of the figures depicting the user interface and associated elements may be associated with a software-implemented process or method that is implemented by a suitably programmed processor or computing device in order to: (a) generate one or more of the depicted user interface elements; (b) permit a user to interact with one or more of the user interface elements (such as by activating an element or entering data into a data field); (c) process a user's selection or activation of a user interface element, or entry of data into a data field; or (d) perform one or more processes, operations or functions associated with the inventive service.

Such processes, operations or functions that are associated with the inventive service include, but are not limited to, providing data that a user may use to select a person to “invite” to open an account; generating an “invitation” to a selected person; determining (or receiving acknowledgment) that the invited person has opened an account; enabling a user to schedule and manage the transfer of funds from their account to the account associated with the invited person; providing information or data regarding awards or rewards that the user may have earned as a result of the invited person's use of the opened account; and providing a set of tools (such as user interface elements) to enable the user to manage the generation of invitations to other persons, transfer funds to accounts associated with one or more of the other persons, and track rewards that the user may be entitled to as a result of the use of an account opened by an invited person.

Note that the “operator” of the inventive service or provider of the inventive product may be an issuer of a payment device associated with the consumer. In this case a bank or credit union may be responsible for managing the service in an effort to increase market penetration and overall use of its payment devices (such as pre-paid cards, other reloadable devices, etc.). However, instead of or in addition to an issuer, another party may operate the inventive service or provide the inventive product as a service for one or more issuers. For example, a payment processing organization such as Visa may operate the service for one or more issuers for whom Visa processes payment transactions that are conducted using payment devices issued by those issuers. In such an embodiment one or more servers operated by Visa as part of the payment processing network of FIG. 6 may execute instructions which provide, among other operations: the generation of the user interfaces; processing of received data; generation of invitations; processing of aspects of the enrollment process for an invited person to enable them to apply for and open a new account; tracking of the status of referrals of the account owner who issued the invitation; and management of the transfer of funds from an account associated with the account owner to an account opened by the invited person.

FIG. 2(a) illustrates a screen shot of exemplary elements of a user interface that may be used to permit a user to “invite” another person to open an account associated with a pre-paid payment device, in accordance with some embodiments of the invention. As shown in the figure, an exemplary user interface may include a group of one or more “windows”, portals, or regions that provide access to user interface elements, where those elements may be used by a consumer to perform various processes, operations, or functions associated with the inventive product or service.

For example, region 202 includes elements that may be used by a consumer or user to perform various functions with regards to the consumer's accounts. For purposes of describing the “invitation” function of an embodiment of the invention, the “Refer a Friend” 204 and “My Referrals” 206 functions are of interest. Activation of the “Refer a Friend” 204 user interface element may cause the display of region 210 as shown. Region 210 may include a description of the product or service 212 (illustrated as “Get rewarded for referring your friends!” and the associated text in the figure), and includes elements that may be used by the consumer to provide the operator of the inventive service with identification and contact information for the “friend” whom the consumer wishes to “invite” to open a pre-paid account (or other suitable type or form of account).

In some embodiments, the consumer may provide a person's name and email address using the user interface (depicted as “Friend Information” 214 in the figure). In some embodiments, the person to be invited may be selected from a list or drop-down menu provided to the consumer. In some embodiments, the source of the names of persons in the list or drop-down menu may be one or more of (a) the consumer's email contacts or (b) people in one of the consumer's social “networks” (such as “friends”, business contacts, persons having similar interests, etc.). The user interface shown in FIG. 2(a) may display an amount which the consumer will receive (depicted as part of the “Referral Information” 216 in the figure) and an identifier associated with the consumer (depicted as the “Enrollment Code” 218 in the figure). Enrollment Code 218 is a data string (typically alphanumeric) that is provided to the invited person. The code may be used by the invited person when they open an account in order to provide a way to track the successful referrals generated by the consumer's invitations.

After selection and/or entry of the requested information, the consumer may submit the information (typically by activating a suitable user interface element) to the operator of the inventive service. The submitted information will be used to send an invitation to the person whose name and email address have been provided, inviting them to open an account (typically a pre-paid or other form of reloadable account). The invitation may include the enrollment code of the consumer (the inviter) so that the invited person may provide that information when applying to open a new account.

As part of the inventive service or as a separate offering by an issuer, the invited person may be assisted to open an account. This may include providing a link or activate-able element which the invited person may use to initiate a process to open a new account. This process may include requesting additional information from that person to enable an issuer to determine if the invited person satisfies the issuer's criteria for opening a new account. If so, then the invited person may be asked to provide other information used to establish and administer the account. Further, the invited person may be provided with a mechanism by which the enrollment code associated with the person from whom they received the invitation may be submitted to the issuer so that the inviter may receive proper credit for a successful referral.

FIG. 2(b) is a flowchart or flow diagram illustrating a set of processes, operations, or functions that may be implemented by a suitably programmed processor or computing device in order to generate the exemplary user interface elements of FIG. 2(a) and to permit a user to interact with those elements. As shown in the figure, a consumer (the “inviter”) is presented with a data entry form (e.g., a web page) which is used by the inventive service to obtain some or all of the information needed to generate an invitation to the invited person (222). If the consumer has entered contact data (such as the name and email address, as indicated by the “Yes” branch at 224) for the person to be invited, then control may pass to step 232. If the consumer has not entered contact information for the person to be invited and instead wishes to select the name of the person to be invited (as indicated by the “No” branch at 224), then the consumer may be presented with a list or menu of potential invitees (226, 228). The list of potential invitees may be obtained from the consumer's email contacts, a list of contacts from a social network to which the consumer belongs, or another suitable source. The consumer then selects the name and/or contact information for the person they wish to invite to open an account (230).

Selection of the name of the person the consumer wishes to invite may result in the automatic population of a displayed form or data entry region. The inventive service then generates an invitation to the person whom the consumer wishes to “invite” to open a new account (232). The invitation may include a description of the offered service or financial product (such as a pre-paid account), a note from the inviter, and the inviter's enrollment code. The invitation may include a link that when activated provides the invited person with an application for the new account. The invitation is then provided to the invited person (234), typically via email, although other forms of communication may be used (such as a phone call or letter). Upon receipt the invited person may decide to apply for the account (236). This may require providing an issuer or other entity with information to determine if the invited person is eligible for the account. If the invited person qualifies for the account, then a new account associated with that person may be opened (238). The enrollment code or other identifier of the person sending the invitation may be used as part of the application process to enable efficient tracking of the referral rewards to which the inviter may be entitled. After opening of the new account, the consumer/inviter may manage the transfer of funds to the account of the invited person (240).

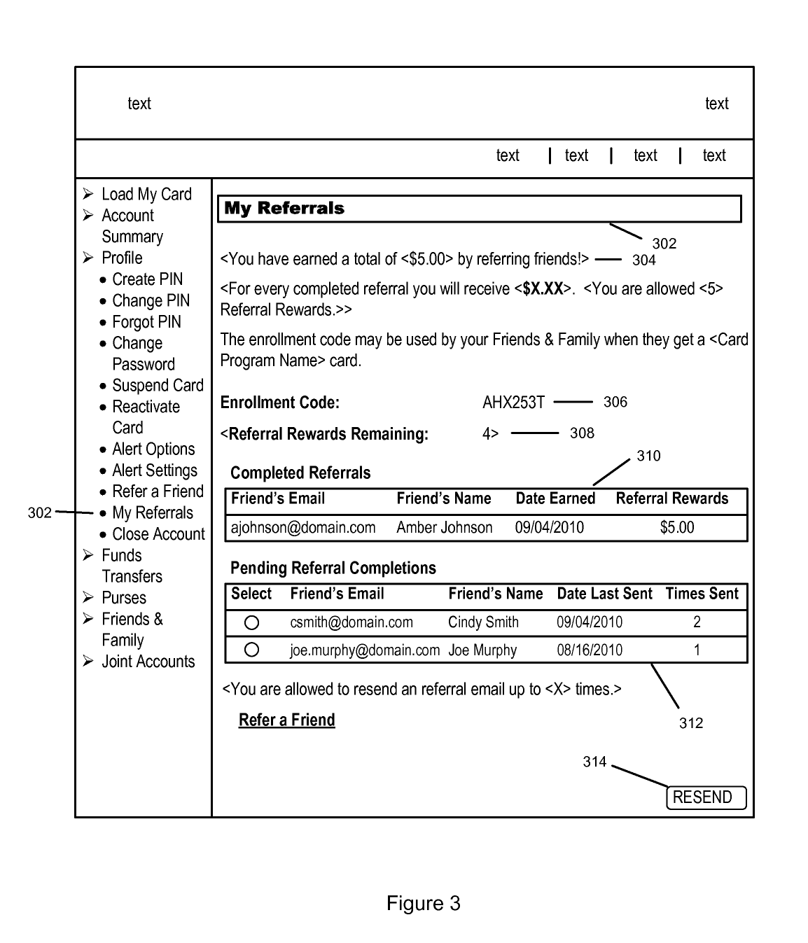

FIG. 3 illustrates a screen shot of exemplary elements of a user interface that may be used to permit a user to keep track of and manage aspects of the “invitations” they have sent others inviting the recipients to open an account associated with a pre-paid payment device and to track the rewards the user receives for those referrals, in accordance with some embodiments of the invention. As shown in the figure, the “My Referrals” (302) page or screen may be used to display to the consumer the status of their previously generated referrals. The My Referrals page or screen may display to the consumer a total amount that they have earned in rewards so far from referrals that resulted in their “friends” using the new account in a manner that satisfied the criteria for earning a reward (304). The My Referrals page may also display the consumer's enrollment code (306), the number of referral rewards that the consumer is still eligible to receive (308), information regarding completed referrals (310; corresponding to referrals that have resulted in the opening of a new account and/or satisfaction of the criteria for earning a reward), and information regarding the status of invitations that were sent by the consumer but which have not yet resulted in the opening of a new account and/or sufficient usage to result in the consumer earning a reward (312). The My Referrals page or screen thus provides the consumer with information regarding the status of their “invitations” and may provide tolls to enable the consumer to “Resend” their invitation (314).

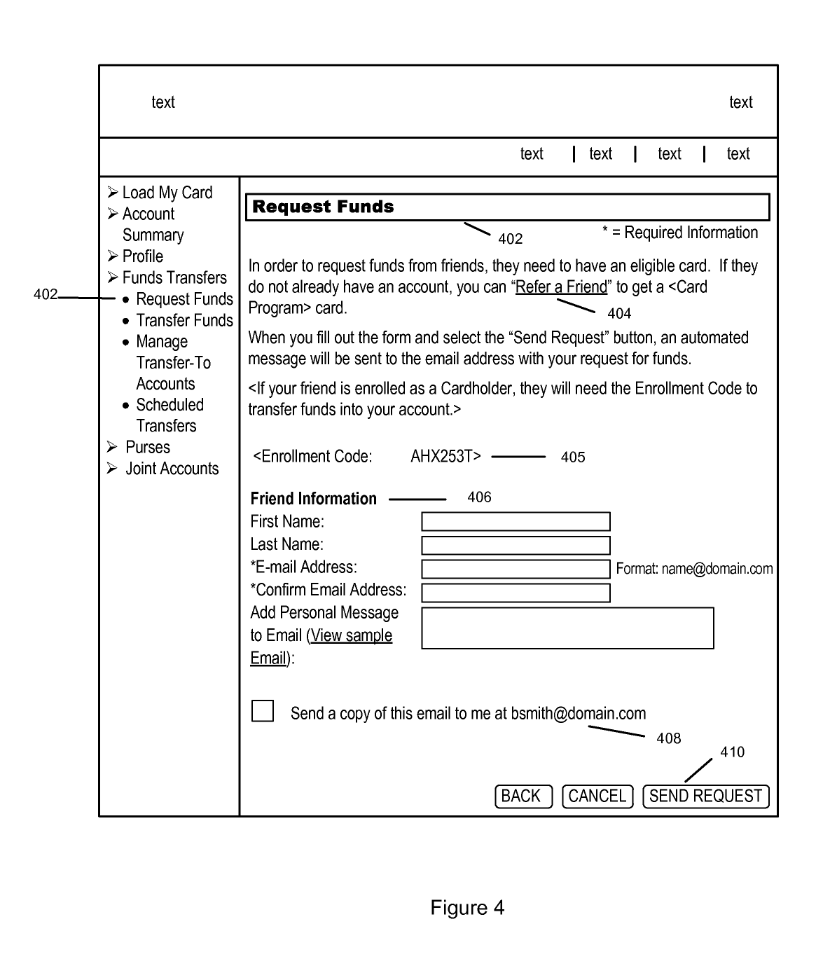

FIG. 4 illustrates a screen shot of exemplary elements of a user interface that may be used to permit a person to request funds from another person, in accordance with some embodiments of the invention. As shown in the figure, the “Request Funds” page or screen may be used to generate a request for funds by one person to another (402). In some cases the person desiring funds may send the person from whom they are requesting funds an “invitation” to open an account (404). In some cases the person requesting funds may provide an enrollment code to the person from whom they are requesting funds (405). Note that the converse situation may also occur; that is, a person already having an account may “offer” to transfer funds to another person. In some cases the person being offered the funds may be invited to open a new account.

Returning to the situation of a person requesting funds from another, the person requesting funds may then enter information identifying the person from whom they are requesting funds (identified as “Friend Information” 406 in the figure). This information may include the name and contact information for the person from whom the funds are being requested (e.g., an email address). The request may also include a personal message. The “Request Funds” page or screen may permit a copy of the request to be sent to the email address of the person requesting the funds (408). After entry of the requested information, the person requesting the funds may activate the “Send Request” user interface element (410) to cause generation and/or transmission of the request to the email address of the indicated person.

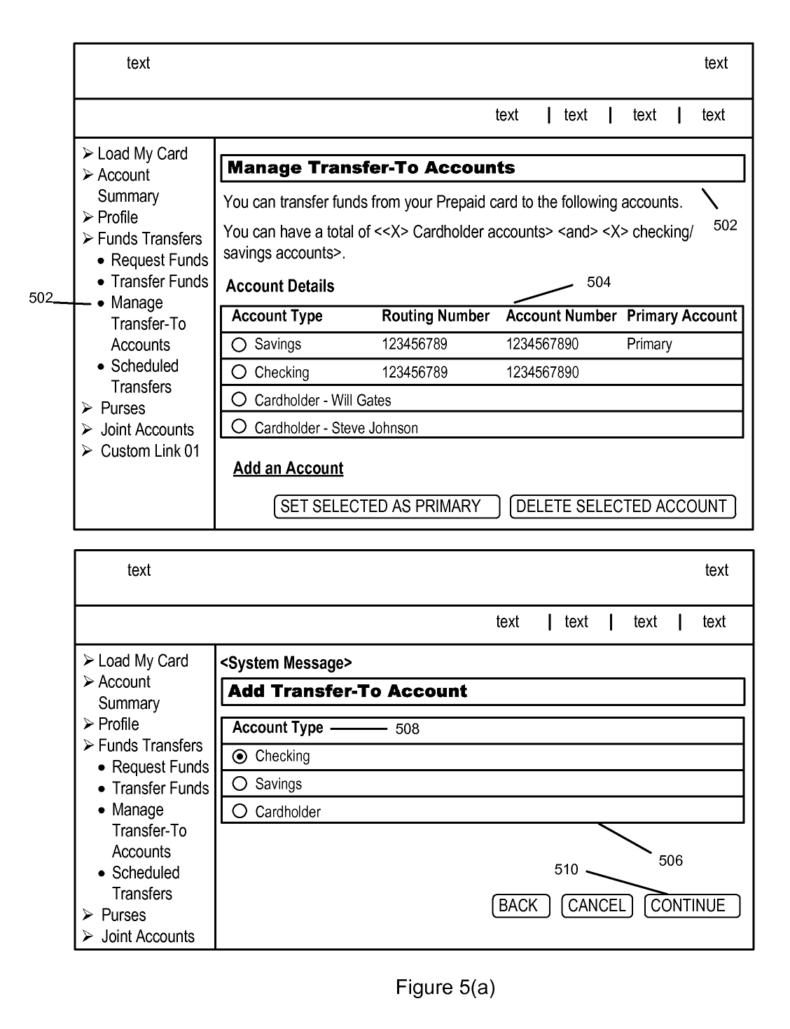

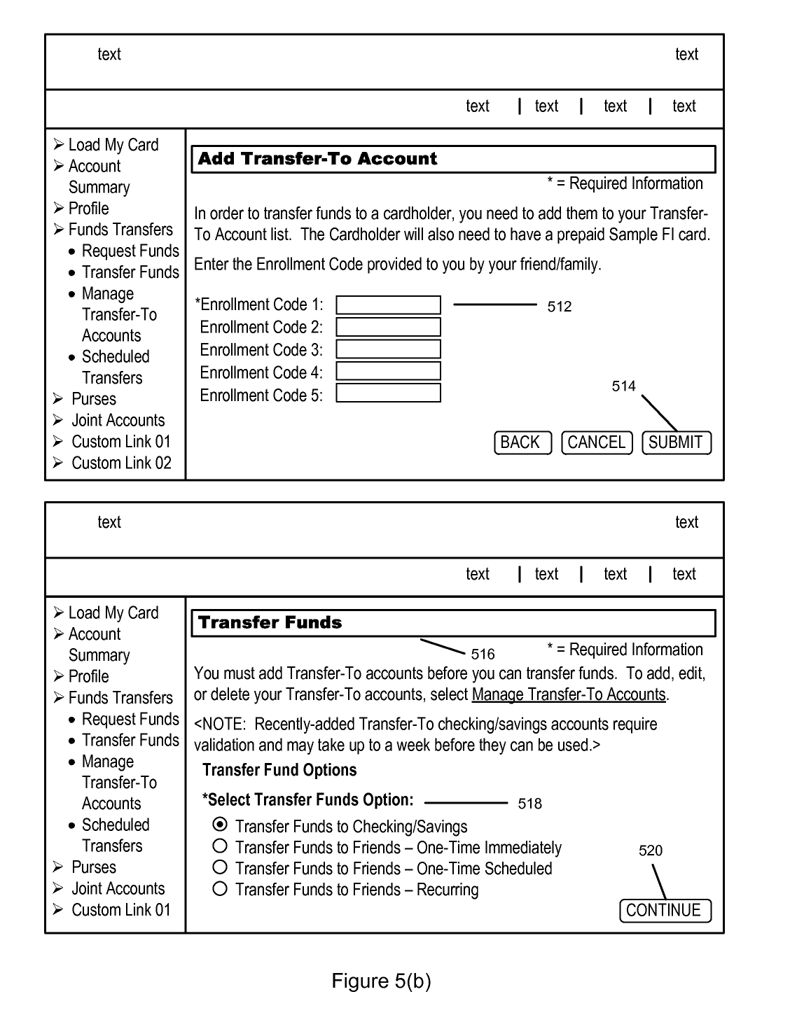

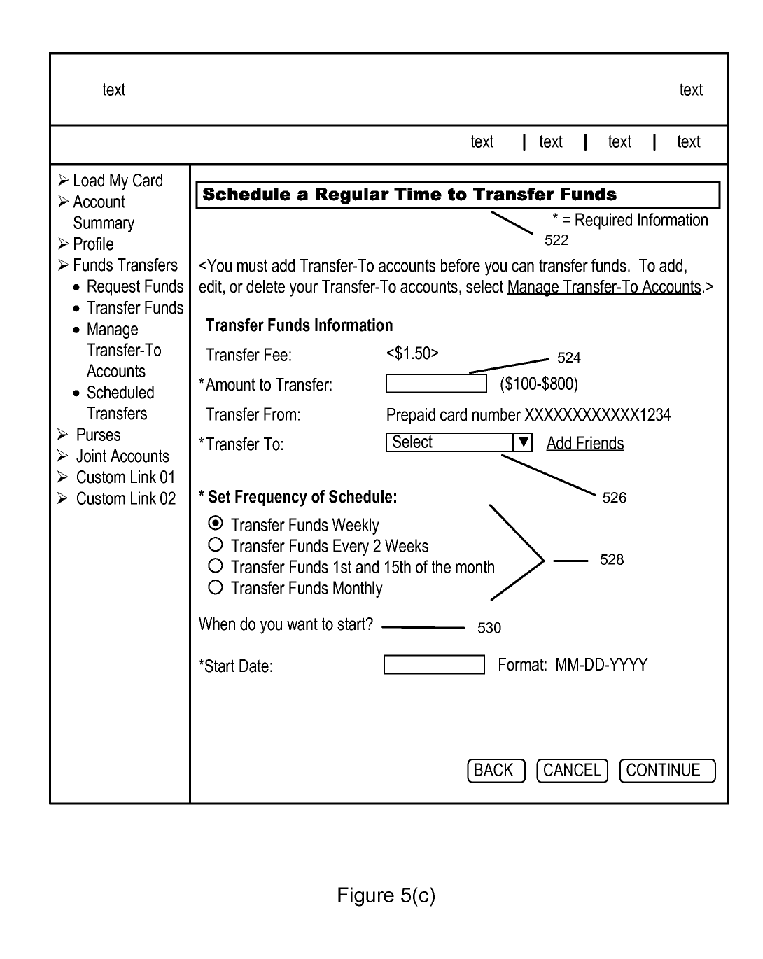

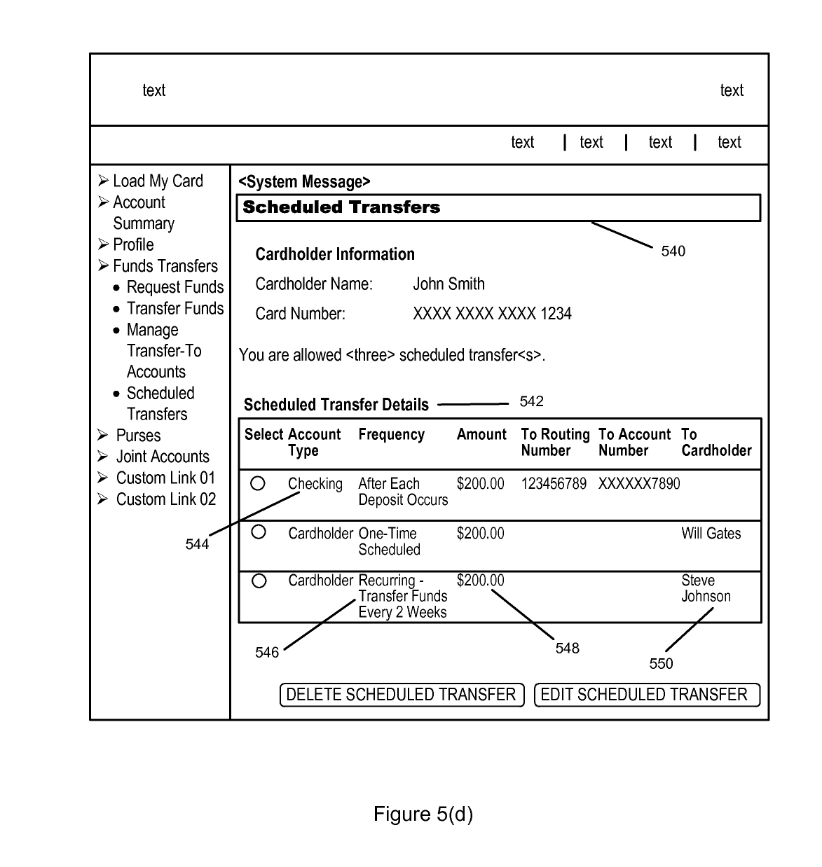

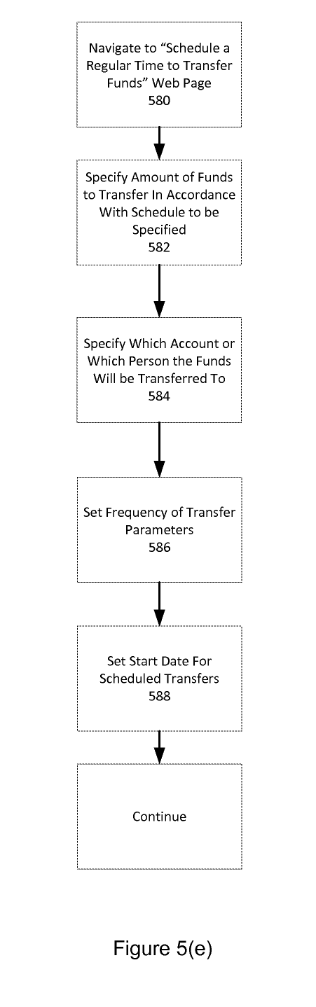

FIGS. 5(a)-5(d) illustrate screen shots of exemplary elements of a user interface that may be used to permit a user to transfer funds between the user's pre-paid account and that of another person, in accordance with some embodiments of the present invention. As shown in FIG. 5(a), the “Manage Transfer-To Accounts” page or screen may be used to manage one person's transfer of funds to another person (502). Such management may include providing a list of accounts to which funds can be transferred from the consumer's pre-paid account (or other suitable account) (504). Such a list may include, for example, one or more of the consumer's own accounts (identified as “Savings” or “Checking” in the figure), and one or more accounts belonging to other people (identified as “Cardholder—Will Gates” or “Cardholder—Steve Johnson” in the figure). Each displayed account may be selectable by use of a button or other user interface element.

The user interface may also provide user interface elements that may be used to add an account to which funds can be transferred (identified as “Add an Account” in the figure), to set a selected account as the “Primary” account, to delete a selected account, or other operations. If the consumer desires to add an account to which funds may be transferred, then an “Add Transfer-To Account” interface may be presented (506). The Add Transfer-To Account interface may include a user interface element that can be used to describe the account to be added (identified as “Account Type” (508) in the figure). The Account Type may include “Checking”, “Savings”, or “Cardholder” among others.

The consumer may select the appropriate account type for the account they wish to add as a Transfer-To Account. The consumer may then select a user interface element labeled “Continue” (510) to continue with the process of adding the new account. Other user interface elements may also be provided to control other aspects of the process (such as “Back” or “Cancel” buttons as shown in the figure).

Continuing with the description and as shown in FIG. 5(b), after activation of the “Continue” button or other form of user interface element, the consumer may need to provide an enrollment code for the account they wish to add as a new Transfer-To Account (512). The enrollment code identifies the account the consumer wishes to add and enables proper tracking of the referral rewards that the consumer, the person to whom the funds are transferred, or both are entitled. The enrollment code may also be used to authenticate the account as one which is entitled to participate in the referral Rewards program. After entry of the enrollment code for the account to be added, the consumer may submit the code (by activation of the “Submit” user interface element, 514).

After submission of the enrollment code, the consumer may be provided a set of user interface elements to enable further operations relating to the transfer of funds between an account belonging to the consumer and the account of another person (this may be the result of displaying a new screen or web page, making a previously displayed screen or section of a screen active, etc.). As shown in the section of user interface elements labeled “Transfer Funds” 516, the consumer may then select which transfer funds option they desire to use for the transfer (labeled “Select Transfer Funds Option” 518 in the figure). As examples, the selectable “options” may include a transfer to the consumer's own checking or savings account, a one time and substantially immediate transfer to the account of another person (labeled “Transfer Funds to Friends—One-Time Immediately” in the figure), a one-time transfer to the account of another person according to a schedule (labeled “Transfer Funds to Friends—One-Time Scheduled” in the figure), or a transfer to the account of another person that is expected to be on a recurring basis (labeled “Transfer Funds to Friends—Recurring” in the figure). After selecting the Transfer Funds Option (518) the consumer may select the “Continue” user interface element (520) to continue the process.

As noted, one of the options for transferring funds to the account of another is to arrange a transfer on a recurring basis. As part of managing this type of funds transfer process, the consumer may desire to specify the parameters of a recurring transfer. FIG. 5(c) illustrates a screen shot of exemplary elements of a user interface that may be used for the purpose of setting those parameters. As shown in the figure, the “Schedule a Regular Time to Transfer Funds” 522 user interface elements may be used to select the amount of funds to transfer (524), the account to which the funds are to be transferred (526) (which may be augmented by the addition of others using the “Add Friends” function), the frequency at which the transfers of the specified amount are to occur (528, as represented by the “Set Frequency of Schedule” element in the figure, and which may include the options shown as well as others), and starting date for the first of the scheduled transfers (530).

FIG. 5(e) is a flowchart or flow diagram illustrating a set of processes, operations, or functions that may be implemented by a suitably programmed processor or computing device in order to generate the exemplary user interface elements of FIG. 5(c) and to permit a user to interact with those elements. As shown in the figure, a consumer (i.e., the person transferring the funds) is presented with a data entry form (e.g., a web page) which is used by the inventive service to obtain some or all of the information needed to arrange for a transfer of a specified amount in accordance with a schedule (580). The consumer then specifies the amount of funds that will be transferred (582). This may be done by entering the desired amount into a text entry field. The account from which the funds are to be transferred may be automatically populated or the consumer may need to select which of their accounts will be the source of the funds (e.g., if they have multiple pre-paid accounts which they use to fund different people or services). Next, the consumer may specify which account (e.g., their own savings or checking account) or which person the funds will be transferred to by the inventive service (584). This may be accomplished by use of a drop-down menu, list or other suitable selection mechanism. The consumer then specifies the frequency with which the transfer is to occur (586). This may be done by selecting one of the proposed schedules (as suggested by element 528 of FIG. 5(c)), and may include such options as weekly, every two weeks, on specific dates of the month, monthly, or other suitable schedules. In some embodiments the consumer may be offered tools to enable definition of their own desired transfer schedule (e.g., after a certain event, every third week, after a certain balance is reached in their own account, after a certain balance is reached in the account of the person receiving the funds, etc.). Next, the consumer may specify a date at which the scheduled transfers are to start (588). This permits the consumer to determine when they want the scheduled transfers to begin, as that may depend on their own financial situation or other plans.

After setting the parameters for one or more scheduled transfers, the consumer may review the scheduled transfers from their account(s) to ensure that the transfers are as intended by the consumer. FIG. 5(d) illustrates a screen shot of exemplary elements of a user interface that may be used for the purpose of reviewing the transfers. As shown in the figure, the “Scheduled Transfers” (540) user interface elements may be used to enable a consumer to review and modify the scheduled transfers. As indicated by the user interface elements at the bottom of the figure, this may include the ability to delete and/or modify a scheduled transfer. The Schedule Transfers user interface may display a list of the scheduled transfers (depicted as “Scheduled Transfer Details” (542)) including, but not limited to, such information as the account type to which the transfer will occur (544), the frequency of the transfer (546, weekly, one-time, after a specified event, etc.), the amount of the transfer (548), and if applicable, the person to whom the transfer will be made (550). The user interface may provide other information if applicable (e.g., the routing and account number for an account to which funds will be transferred).

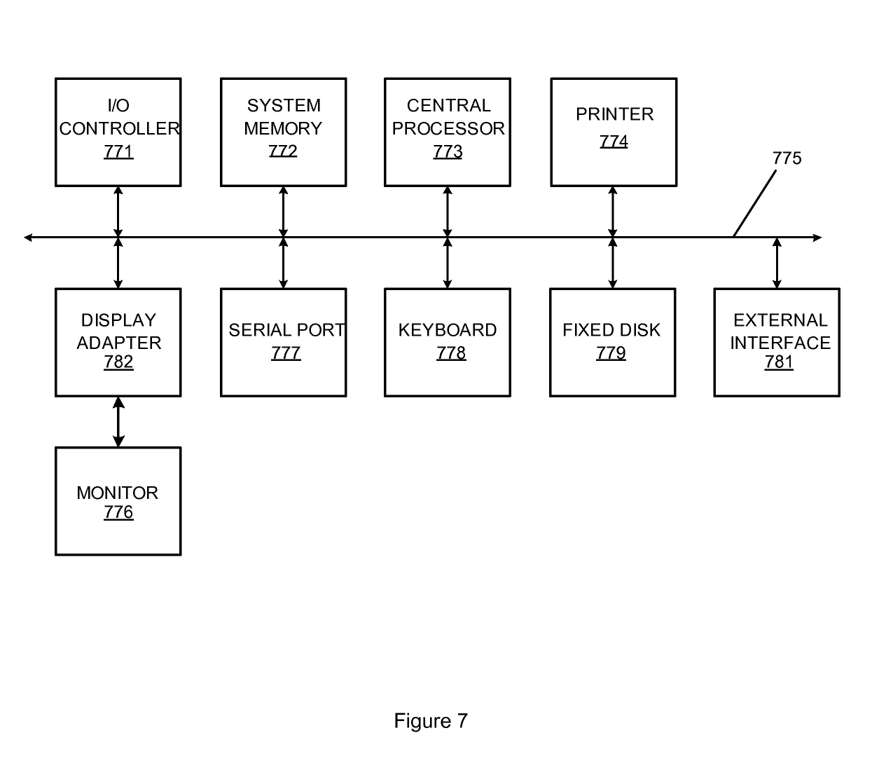

As noted, in some embodiments, the inventive methods, processes or operations may be wholly or partially implemented in the form of a set of instructions executed by a suitably programmed processor, central processing unit (CPU), or microprocessor. The processor, CPU, or microprocessor may be incorporated in an apparatus, server or other data processing device operated by, or in communication with, a node of the transaction authorization network (such as a payment processor or element of a payment processing network 26 of FIG. 6). As an example, FIG. 7 is a block diagram of elements that may be present in a computing device or system configured to execute a method or process in accordance with some embodiments of the present invention. The subsystems shown in FIG. 7 are interconnected via a system bus 775. Additional subsystems such as a printer 774, a keyboard 778, a fixed disk 779, a monitor 776, which is coupled to a display adapter 782, and others are shown. Peripherals and input/output (I/O) devices, which couple to an I/O controller 771, can be connected to the computing system by any number of means known in the art, such as a serial port 777. For example, the serial port 777 or an external interface 781 can be used to connect the computing device to a wide area network such as the Internet, a mouse input device, or a scanner. The interconnection via the system bus 775 allows a central processor 773 to communicate with each subsystem and to control the execution of instructions that may be stored in a system memory 772 or the fixed disk 779, as well as the exchange of information between subsystems. The system memory 772 and/or the fixed disk 779 may embody a computer readable medium.

Embodiments of the invention provide a technical solution to problems associated with increasing the distribution and use of certain payment devices, such as pre-paid cards. These problems include how to more efficiently increase the rate at which new accounts are opened, how to facilitate the transfer of funds between accounts, and how to enable consumers to efficiently determine a schedule by which they can automatically provide funds to the account of another person. Embodiments of the invention solve these and other problems by providing a set of technical tools (e.g., user interface elements) to enable a consumer to specify a person to “invite” to open a new account, link the consumer's pre-paid account to the new pre-paid account opened by the invited person, specify a schedule for transferring funds between their account and that of the invited person, track the invitations they have sent and the response of the invited person, and track any rewards they are entitled to as a result of the invited person's use of the new account. Embodiments of the invention may increase the adoption and use of pre-paid devices among a group that represents a new and previously untapped market for the payment devices. Embodiments also facilitate an orderly transfer of funds between two parties, such as between a parent and child. Embodiments also may increase the eventual use of other financial services offered by an issuer or payment processing organization.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A computer-implemented method, comprising:
enabling a current owner of a pre-paid account to identify a person to invite to open a new pre-paid account;
generating an electronic invitation to the identified person on behalf of the current owner of the pre-paid account;
receiving acknowledgement that the identified person opened the new pre-paid account;
enabling the current owner of the pre-paid account to electronically transfer funds to the identified person who opened the new pre-paid account;
determining that the new pre-paid account has been used in a manner that satisfies a criteria for a referral reward;
providing the referral reward to the current owner of the pre-paid account; and
providing a user interface displayed on an electronic device and configured to permit the current owner of the pre-paid account to view a status of the invitation and a status of the referral reward.

2. The computer-implemented method of claim 1, wherein enabling the current owner of the pre-paid account to identify the person to invite to open the new pre-paid account further comprises:
enabling the current owner of the pre-paid account to select the person to invite from a list containing names of one or more of email contacts, phone contacts, or members of a common social network.

3. The computer-implemented method of claim 1, wherein enabling the current owner of the pre-paid account to electronically transfer funds to the identified person who opened the new pre-paid account further comprises providing the current owner with a set of user interface elements with which they may interact to specify an amount of funds to be transferred.

4. The computer-implemented method of claim 1, wherein enabling the current owner of the pre-paid account to electronically transfer funds to the identified person who opened the new pre-paid account further comprises providing the current owner with a set of user interface elements with which they may interact to specify a schedule for transferring the funds.

5. The computer-implemented method of claim 1, wherein enabling the current owner of the pre-paid account to electronically transfer funds to the identified person who opened the new pre-paid account further comprises providing the current owner with a set of user interface elements with which they may interact to specify a starting date for transferring the funds.

6. The computer-implemented method of claim 1, wherein the criteria for the referral reward includes one or more of a total number of transactions for which the new pre-paid account is used, a total value of transactions for which the new pre-paid account is used, a total number of times the current owner of the pre-paid account electronically transfers funds to the new pre-paid account, or a total value of the funds that the current owner of the pre-paid account electronically transfers to the new pre-paid account.

7. The computer-implemented method of claim 1, further comprising generating a user interface to enable the person invited to open the new pre-paid account to request funds from the current owner of the pre-paid account.

8. The computer-implemented method of claim 1, wherein generating an electronic invitation to the identified person on behalf of the current owner of the pre-paid account further comprises generating the invitation including an enrollment code for the current owner of the pre-paid account.

9. The computer-implemented method of claim 1, wherein some portion of the referral reward is provided to the identified person who opened the new pre-paid account.

10. An apparatus, comprising:
an electronic processor programmed to execute a set of instructions; and
a data storage device coupled to the processor and having the set of instructions stored therein, wherein when the set of instructions are executed by the processor, the apparatus operates to
enable a current owner of a pre-paid account to identify a person to invite to open a new pre-paid account;
generate an electronic invitation to the identified person on behalf of the current owner of the pre-paid account;
receive acknowledgement that the identified person opened the new pre-paid account;
enable the current owner of the pre-paid account to electronically transfer funds to the identified person who opened the new pre-paid account;
determine that the new pre-paid account has been used in a manner that satisfies a criteria for a referral reward;
provide the referral reward to the current owner of the pre-paid account; and
provide a user interface displayed on an electronic device and configured to permit the current owner of the pre-paid account to view a status of the invitation and a status of the referral reward.

11. The apparatus of claim 10, wherein enabling the current owner of the pre-paid account to identify the person to invite to open the new pre-paid account further comprises:
enabling the current owner of the pre-paid account to select the person to invite from a list containing names of one or more of email contacts, phone contacts, or members of a common social network.

12. The apparatus of claim 10, wherein enabling the current owner of the pre-paid account to electronically transfer funds to the identified person who opened the new pre-paid account further comprises providing the current owner with a set of user interface elements with which they may interact to specify an amount of funds to be transferred.

13. The apparatus of claim 10, wherein enabling the current owner of the pre-paid account to electronically transfer funds to the identified person who opened the new pre-paid account further comprises providing the current owner with a set of user interface elements with which they may interact to specify a schedule for transferring the funds.

14. The apparatus of claim 10, wherein enabling the current owner of the pre-paid account to electronically transfer funds to the identified person who opened the new pre-paid account further comprises providing the current owner with a set of user interface elements with which they may interact to specify a starting date for transferring the funds.

15. The apparatus of claim 10, wherein the criteria for the referral reward includes one or more of a total number of transactions for which the new pre-paid account is used, a total value of transactions for which the new pre-paid account is used, a total number of times the current owner of the pre-paid account electronically transfers funds to the new pre-paid account, or a total value of the funds that the current owner of the pre-paid account electronically transfers to the new pre-paid account.

16. The apparatus of claim 10, further comprising instructions which when executed by the electronic processor generate a user interface to enable the person invited to open the new pre-paid account to request funds from the current owner of the pre-paid account.

17. The apparatus of claim 10, wherein generating an electronic invitation to the identified person on behalf of the current owner of the pre-paid account further comprises generating the invitation including an enrollment code for the current owner of the pre-paid account.

18. The apparatus of claim 10, wherein some portion of the referral reward is provided to the identified person who opened the new pre-paid account.
